(19) United States
(12) Patent Application Publication
(10) Pub. No.: US 2018/0201792 A1
(43) Pub. Date: Jul. 19, 2018

(54) INSULATIVE AND FLAME RETARDANT PAINT PRIMER FOR PAINT APPLICATIONS

(71) Applicants: ANTONIOS STERGIOS ECONOMOS, BURBANK, CA (US); MARIA A. ECONOMOS, BURBANK, CA (US)

(72) Inventors: ANTONIOS STERGIOS ECONOMOS, BURBANK, CA (US); MARIA A. ECONOMOS, BURBANK, CA (US)

(21) Appl. No.: 15/872,815

(22) Filed: Jan. 16, 2018

Related U.S. Application Data
(60) Provisional application No. 62/446,828, filed on Jan. 16, 2017.

(51) Int. Cl. C09D 5/00; C09D 7/40; C09D 5/18

(52) U.S. Cl. CPC C09D 5/002; C09D 5/18; C09D 7/70

(57) ABSTRACT

A multi-purpose primer for painting applications for both interior and exterior usage acts as both a thermal insulator and a flame retardant for substrates and surfaces in industrial, commercial, military, and residential buildings and structures. The primer includes a plurality of hollow microspheres that shrink to a tightly-packed layer as the primer dries, and a flame-retardant additive, to provide an insulating, protective barrier. The primer produces a high quality, white-pigmented acrylic sealer which reduces heating and cooling requirements and costs. The primer is also a Class A-certified paint that retards flame spread by forming a burn-resistant layer that slows the spread of flames to insulate the underlying substrate and surface from fire.

### CROSS-REFERENCE TO RELATED PATENT APPLICATION(S)

This patent application claims priority to U.S. provisional application 62/446,828, filed on Jan. 16, 2017, the contents of which are incorporated in their entirety herein. In accordance with 37 C.F.R. § 1.76, a claim of priority is included in an Application Data Sheet filed concurrently herewith.

### FIELD OF THE INVENTION

The present invention relates to a preparatory technical coating, or primer, for paint. Specifically, the present invention relates to an undercoating primer for application to a substrate or surface prior to one or more layers of paint, that has both insulative and flame-retardant properties for both interior and exterior usage.

### BACKGROUND OF THE INVENTION

A primer is a preparatory coating that is applied to a substrate or surface prior to the application of one or more layers of additional coating or finishing paint. A preparatory coating provides better adhesion of paint to the substrate or surface, provides additional protection for the materials of the substrate or surface being painted, and also increases paint durability.

Existing primers are often comprised of materials which do not provide enough protection for the finishing layers of paint or for the material being painted. This may result in reduced paint durability and life-cycle, as well as damage to the surface to which the primer and paint is applied. Additionally, primers do not provide thermal insulation to deflect the sun's rays during warm months, while insulating against lower temperatures in colder months, while also being heat-resistant and water-resistant. Furthermore, existing primers that do provide thermal insulation do not include fire protection components that make them flame retardant for more comprehensive protection for the surface being painted.

Accordingly there is a need in the existing art for primers for painting applications that incorporate components that enable both improved thermal insulation and fire retardation characteristics for both interior and exterior usage. At the same time, there is a need for primers for painting applications that promote greater energy savings and which are also less toxic and more environmentally friendly for residential, commercial, industrial, military, and other uses.

### BRIEF SUMMARY OF THE INVENTION

The present invention therefore provides a heat-reflective insulator and flame-retardant technical undercoating, or primer, for painting applications. This multi-purpose primer is applicable for both interior and exterior usage in industrial, commercial, military, and residential painting applications.

The primer provides a high-quality, multi-purpose exterior and interior primer that is fortified with a high-strength and environmentally-friendly blend of organic, hollow microspheres that produces a barrier for thermal insulation. This barrier acts as a protective shield by deflecting the sun's rays during the warm and hot months, and an insulating against cold weather during winter months. The primer reduces heating and cooling requirements for homes, schools, offices, and commercial and industrial buildings. The primer may be used on any suitable surface or substrate, such as for example brick, concrete, drywall, masonry, plaster, stucco, metal, wood, and other surfaces. Once applied, the primer may be top-coated with either latex or oil based paint or used as a final coat, for example in textured ceilings, attics, dropped ceilings, painted plaster, metal, stucco, painted wood and other surfaces. Water-based, colorized paint may also be added to tint the color of the primer for use as a final coating.

The primer also provides a coating layer comprised of flame-retardant compounds that insulates the substrate from fire by slowing or even preventing the spread of flames. The primer slows smoke development in the event of a fire, reduces the risk of injury from smoke inhalation, and enables more time for safe evacuation. Together, the microspheres and flame-retardant compounds combine to increase both thermal insulation properties and the fire resistance properties of the technical coating or primer to which they are added.

The primer of the present invention provides, in one exemplary embodiment thereof, a sustainable and environmentally-friendly, water-based, white-pigmented, energy-saving acrylic primer. The primer serves as both a high-quality thermal insulating barrier, and flame-retardant barrier. The primer is water resistant, UV-Ray resistant, heat flow resistant, and fire resistant. The primer also resists corrosion, abrasion, mold and mildew, and reduces the energy required to heat a structure, and the energy required to cool a structure, and is a highly cost-effective improvement upon existing solutions.

In one embodiment, the present invention is a primer for both interior and exterior usage in painting applications, comprising, in a water-based coating applied to a substrate, a plurality of microspheres in an amount that forms a tightly-packed layer during a drying process of the coating, the plurality of microspheres each having a shape allowing them to roll upon each other to enable the water-based coating to spread evenly during an application of the water-based coating and produce a resultant primer that reflects, refracts and dissipates heat by reducing a path for heat transfer throughout the water-based coating. The primer includes a flame-retardant additive in an amount that insulates the substrate from fire, by forming a burn-resistant barrier within the water-based coating; and one or more components that include water, pigments, adhesives, sealants, polymers, and other chemical compounds that promote thermal insulation and flame retardation in a cohesive combination with the plurality of hollow microspheres and the flame-retardant additive.

In another embodiment, the present invention is a coating applied to a substrate in painting applications, comprising water, in an amount between approximately between 10%-15% percentage weight of the coating a plurality of hollow microspheres in an amount comprising between 20%-30% percentage of the coating that forms a tightly-packed layer during a drying process of the coating, the plurality of hollow microspheres each having a shape allowing them to roll upon each other to enable the coating to spread evenly during an application of the coating and produce a resultant primer that reflects, refracts and dissipates heat by reducing a path for heat transfer throughout the coating, and a flame-retardant additive in an amount comprising approximately 3%-10% percentage weight of the coating, the flame-retardant additive insulating the substrate from fire, by forming a burn-resistant barrier within the coating.

It is therefore one objective of the present invention to provide a multi-purpose primer for both interior and exterior usage in painting applications. It is another objective of the present invention to provide a primer for painting applications that is suitable as a thermally-insulating undercoat. It is still another objective of the present invention to provide a primer for painting applications that is suitable as a thermally insulating undercoat, and which is also capable of meeting the highest certification standards as a flame retardant. Still another objective of the present invention is to provide a technical primer that serves as an energy-saving coating for any surface or substrate. Yet another objective of the present invention is to create an additional barrier for protection of a substrate or surface against fire. Additionally, another objective of the present invention is to provide a technical primer that serves as a cost-saving coating for any surface or substrate that produces a substantial reduction in energy usage and overall utility costs, for example in a structure on which the primer is applied.

Other objects, embodiments, features, and advantages of the present invention will become apparent from the following description of the embodiments, which illustrate, by way of example, principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is an illustration of a components of a primer, and a drying or evaporation process in which thermal insulation properties and flame retardation properties are combined in said primer, according to the present invention.

### DETAILED DESCRIPTION OF THE INVENTION

In the following description of the present invention, reference is made to the exemplary embodiments illustrating the principles of the present invention and how it is practiced. Other embodiments will be utilized to practice the present invention and structural and functional changes will be made thereto without departing from the scope of the present invention.

The present invention is a multi-purpose primer 100 for painting applications for both interior and exterior usage. The primer 100 acts as both a thermal insulator and a fire-protective flame retardant for surfaces in industrial, commercial, military, and residential buildings and structures, as well as equipment, fixtures, and other items. The primer 100 produces a high quality, white-pigmented acrylic sealer and provides an insulating barrier which reduces heating and cooling requirements and costs in any setting. The primer 100 is also a Class A-certified paint that retards flame spread by forming a burn-resistant barrier, insulating the underlying substrate from flames, and slowing flame spread.

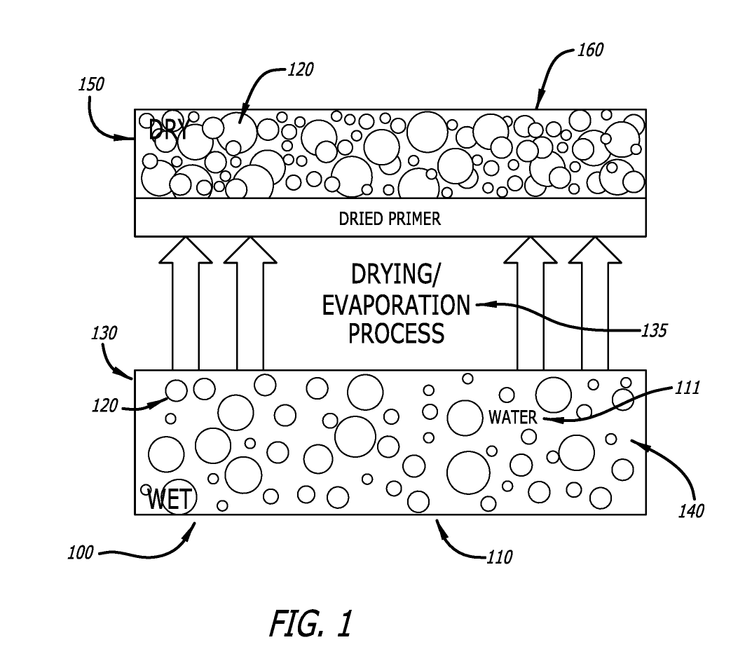

FIG. 1 is a pictorial diagram illustrating components in the multi-purpose primer 100, and a process of forming an insulative, fire-protection coating comprising such a primer 100 for a surface or substrate 160. The primer 100 includes multiple components 110 that allow it to act as a suitable undercoat in painting applications. These components include water 111, and chemical compounds such as propylene glycol 112 (not shown), and various pigments 113 (not shown), such as for example, titanium dioxide. Other ingredients include additives 114 (not shown) such as coalescents (for example, ester alcohol), adhesives and sealants. The primer 100 may further include other components 115 (not shown) such as surfactants that aid in wetting and detergency for pigment dispersion, ammonia or other neutralizing amines, silicone de-foamers, silicone, polymers such as a styrene acrylic emulsion polymer designed to promote stain blocking resistance, rust inhibitors, preservatives such as a water soluble liquid preservative, and thickeners.

Water 111 is present in amount comprising between 5% and 20% of the overall composition of the primer 100. In one embodiment, water 111 may comprise between approximately 6 ounces and 30 ounces of a gallon of primer 100. In a further embodiment, water 111 may comprise between approximately 10% and 15% of the solution forming the primer 100, so that the water 111 is between approximately 10 ounces to 20 ounces of a gallon of the primer 100. It is to be understood however that any amount of water may be present in the primer 100, and that this disclosure is not to be limited to any amount of water specified herein. Water 111 may also be added to the primer 100 at various points in its life cycle to increase its solvency, and depending on an amount of solids present in the solution, and it is to be understood that more or less water than any amount specified herein does not alter the thermal insulation or flame retardation properties of the primer 100.

The primer 100 of the present invention also includes a plurality of hard, hollow microspheres 120, such as ceramic beads. Such beads may further be organic. When the primer 100 is applied to a surface or substrate 160, it shrinks to a tightly-packed layer of these microspheres 120 as the primer begins to dry in a drying/evaporation process 135. Their spherical shape allows them to act like ball bearings and roll upon each other during an application of the primer 100 to a surface or substrate 160, thus allowing the coating to spread evenly and flow more easily around the microspheres 120. The resulting dried layer 150 reflects, refracts and dissipates heat by minimizing the path for heat transfer of solar rays and UV rays being radiated back to the atmosphere through a coating formed by the primer 100. During the evaporation/drying process 135, the microspheres therefore form a densely compact dried barrier layer 150 that acts as a thermal insulator. The primer 100 also includes a flame-retardant additive 140 that is either added to the primer 100 while it is still wet in a wet layer 130, or added during the manufacturing process. The flame-retardant additive may be proprietary or commercially available.

As noted above, the primer 100 shrinks during the drying process 135. When wet, the primer 100 may have a thickness of about 20 millimeters, but during the drying process 135 the thickness shrinks to about 10 millimeters. Therefore, the primer 100 shrinks about 50%, and the presence of at least the microspheres 120 limits the shrinkage of the primer 100 to this percentage. It is to be understood that varying quantities of the microspheres 120 (and other components 110, including the flame-retardant additive 140) may influence these thicknesses, depending on the formulation needed, and therefore the wet and dry thicknesses of the primer 100 may also vary. For example, in one embodiment of the present invention, the primer 100 may have a thickness of between approximately 16-20 millimeters when wet, but during the drying process 135 the thickness shrinks to between approximately 8-10 millimeters. It is to be understood that many ranges are possible, and the present invention is not to be limited by any one range or amount referenced herein.

The primer 100 is mixed in a process that occurs, in one exemplary embodiment, in a batch mixing tub having a calibrated scale. The batch mixing tub is filled initially with water 111 to a desired amount depending on batch specifications. Once this has been calibrated to the proper amount, components such as propylene glycols, 112 ester alcohols 114, and surfactants 115 (for example, propylene glycol, Texanol™, and Triton™ CF-10) are measured into the water 111 and added to the batch. Then, pigments such as for example Attagel®, and thickeners (for example, a cellulose ether) such as for example Tylose®, are then weighed and also added to the batch. Then, wetting and dispersal agents (such as for example BYK®-156 and BYK®-022) are also weighed out and further added to the batch. Other pigments and fillers are then added (such as titanium dioxide) are then added to the mixture, as well as a neutralizing amine additive (such as for example Advantex™.) At this point, the ingredients may be milled to ensure that they are properly mixed together.

Fire protection and thermal insulation components are then added to the mixture. Thermal insulation properties and fire protection properties are provided by the plurality of hollow microspheres 120, and additional fire protection properties are provided by a flame-retardant additive 140. Together, these components 120 and 140 form a burn-resistant barrier in the resultant dry layer 150 for both interior and exterior paint applications, thereby insulating the substrate 160 and slowing the spread of flames.

The combination of the plurality of hollow microspheres 120 and flame-retardant additive 140 together enhance the fire protection properties of the primer 100 at least because the spherical shape of the plurality of microspheres enable the flame-retardant additive 140 to spread evenly over the entire surface areas of the microspheres 120 as they dry and form the tightly-packed resultant dry layer 150. The molecular bonds formed between the flame retardant additive 140 and the microspheres 120 increase the absorption and coverage of the additive 140 as the microspheres 120 roll upon each other during the drying process. This results in greater surface area for powderized flame-retardant additive 140 in the primer 100, produced enhancements in fire protection.

A binding process between the surfaces of the microspheres 120 and the flame-retardant additive 140 may occur due to presence of one or more of the components 110 comprising the rest of the primer 100. For example, the components 110 may include a resin that acts to tighten the bond between surfaces of the microspheres 120 and flame-retardant additive 140. Other components 110 may also reinforce these bonds, either in combination with a resin or in addition to a resin, to create improvements in the mariner in which the flame-retardant additive 140 bonds with microspheres 120 to improve surface area coverage in the dry layer 150. Additionally, many types of resin are possible, for example acrylic resins.

Examples of other binding components 1100 may include combinations of materials, such as pigments, which are dry colorants that are often powderized and added to a binder such as a resin for adhesion. Binding components 110 may be dry or wet, and may be a combination of wet and dry components. For example, an emulsion may be used as a binder, or in combination with other binders, by combining liquids in the primer 100.

This process for mixing the primer 100 then continues by adding a defoamer (such as for example BYK®-035), and one or more polymers, such as styrene acrylic emulsion polymer (for example Raykote® 2000). Other components that may be added include a rust inhibitor (such as Raybo 60), preservatives (such as Mergal, are then weighed and added to the batch. Any other additional additives may also be added at this staged, followed by a further mix of additional proprietary components in the hollow microspheres 120 and the flame retardant additive 140 that enhance the thermal insulation and fire protection properties. The resultant batch is then stirred and mixed further.

A single organic hollow microsphere 120 has a wall thickness about 1/10 of its diameter, a compressive strength range of 6,500-60,000 psi, a softening point of about 1800° C. The microspheres 120 are chemical resistant and non-combustible with a thermal conductivity of 0.1 watt/meter/° C., allowing them to promote the heat-resistant, thermally-insulating characteristics of the primer 100.

In an exemplary embodiment, these microspheres 120 are added to the primer 100 in an amount comprising a ratio of between 8%-20% of the total liquid volume of the primer 100. For example, a gallon (128 ounces) of primer 100 may include 12 ounces of microspheres 120. In another exemplary embodiment, these microspheres 120 are added to the primer 100 in an amount comprising a ratio of approximately 25% of the total liquid volume of the primer 100. For example, a gallon (128 ounces) of primer 100 may include 32 ounces of microspheres 120. Regardless, it is to be understood, that any ratio of microspheres to overall total liquid volume, and any amount of such microspheres 120, may be included to arrive at the appropriate level of thermal insulation and fire protection for the substrate 160 and paint with which the primer 100 is to be used. It is also to be understood that these ratios may change depending on the intended use of the primer 100 and the substrate 160 or structure upon which it is applied, as well as on the intended climate and the intended market and its respective regulatory and testing restraints. Therefore, the present invention is not to be limited to any ratio or amount specifically disclosed herein.

Additionally, the microspheres 120 may be made of a ceramic material, or any other similarly suitable material to achieve the insulating objectives described herein. Microspheres 120 may also be comprised of many different materials in the same batch, such that not all microspheres need to be ceramic (for example). Therefore, the present invention is also not to be limited to any type of material comprising the microspheres 120 that is specifically disclosed herein. Additionally, the microspheres 120 need not be entirely hollow, or hard. It is to be understood that many types, sizes, shapes, and components materials comprising such microspheres 120 may be included.

As noted above, another component of the primer 100 of the present invention is an additive 140 that is designed to blend with the other ingredients in an amount that forms a suitable fire-protective, flame-retardant coating to insulate the underlying substrate 160 from the flame, and consequently, slow the spread of flames. Such a flame-retardant additive 140 may be added to the primer 100, in an exemplary embodiment of the present invention, in an amount comprising a ratio of between 3%-10% of the total liquid volume of the primer. For example, a gallon of primer 100 may include 6 ounces of such a flame-retardant additive 140. In another exemplary embodiment of the present invention, a flame-retardant additive 140 may be added in an amount comprising 5% or more of the total liquid volume of the primer. In such an example, a gallon (128 ounces) of primer 100 may include 6 ounces or more of such a flame-retardant additive 140. Regardless, it is to be understood, that any ratio of flame retardant 140 to overall total liquid volume, and any amount of such a flame retardant, may be included. It is also to be understood that these ratios may change depending on the intended use of the primer 100 and the substrate 160 or structure upon which it is applied, as well as on the intended climate and the intended market and its respective regulatory and testing restraints. Therefore, the present invention is not to be limited to any ratio or amount specifically disclosed herein.

Flame- and fire-retardant additives are chemical compounds added to paints and coatings to inhibit and retard ignition and burning to protect the underlying substrate 160, surface, or structure. These chemical compounds typically are granular solids that can be broadly classified as one of inorganic, halogenated, brominated, nitrogen-based and phosphorous-based, and have many applications, and may contain ingredients that enable crossover classification as well. For example, inorganic compounds such as hydrated aluminum and magnesium oxides are used in flame retardants, and may be used in conjunction with other materials in bromine-, phosphorus- or nitrogen-based flame retardants. Flame retardants typically work by slowing down the decomposition process and the release of flammable gases that fuel the combustion process, and release inert gases that interrupt the chemical chain reaction producing flames. This creates a flame-resistant layer on a material's surface, reducing the release of flammable gases and slowing the spread of fire.

Flame retardants are useful in structural applications, such as for schools, churches, homes, and any other buildings for which substantial protection from fire is desired. Another example is in marine applications, where ships are repeatedly painted to prevent corrosion, and the build-up of paint layers increases the risk of fire which can damage the vessel and threaten life and property. In this example, fire retardant coatings must be painted on the vessel to decrease the risk of fire and damage.

It is to be understood that both the presence of microspheres 120 and the flame-retardant additive 140 contribute to fire prevention properties in the primer 100. Therefore, amounts of each of these components may vary depending on the presence of the other component, and so therefore many combinations of rations of each component in relation to the overall volume of primer 100 are possible. Additionally, these components 120 and 140 may be added at different stages of the mixing process for the primer 100 as suggested above to arrive at the desired thermal insulation and fire protection properties for the application to which the primer 100 is intended.

It is to be further understood that amounts and ratios of other components of the primer 100 may influence the performance of one or both of the plurality of microspheres 120 and the flame-retardant additive 140. For example, inert materials and certain pigments may be removed and replaced with other similar components to promote movement of microspheres 120 in the primer and maximize the performance of one or both of the plurality of microspheres 120 and the flame retardant additive 140, depending at least in part on the amounts and ratios of the plurality of microspheres 120 and the flame retardant additive 140, the intended surface or substrate 160, and other factors such as weather, customer and regulatory requirements, type of application, and the type of finishing paint to be used.

It is to be further understood that materials other than paint may be applied directly to, or on top of, the primer 100 of the present invention. For example, tiles or other roofing materials may be placed directly onto the primer 100 without the need for a finishing topcoat, without deviating at all from the performance benefits realized by the plurality of microspheres 120 and the flame-retardant additive 140. The primer 100 may also be applied to an interior surface of an exterior material without any deviation from the performance benefits realized by the plurality of microspheres 120 and the flame-retardant additive 140. For example, the primer 100 of the present invention may be applied to one surface of panels that is then applied directly to a substrate 160, such as a wall.

It is to be additionally understood that a primer 100 according to the present invention may include either one or both of the thermally-insulating and fire retardation properties described herein. Accordingly, the primer 100 of the present invention need not have both microspheres 120 and a flame-retardant additive 140.

Additionally, use of the primer 100 of the present invention is not to be limited to building or structures. The primer 100 may also have utility on industrial fixtures, equipment, and other such items. Accordingly, it is to be understood that industrial, commercial, military, and residential applications may include both fixed and non-fixed articles. For example, the primer 100 may be adapted for use on airplanes, weaponry, commercial equipment, and other items where a primer 100 exhibiting either or both thermal insulation and fire retardation properties as described herein are desired.

In one embodiment of the present invention, the primer 100 may also be adapted for use in specific residential and commercial applications, such as for example in swimming pools. The primer 100 may provide reflective properties that enable water in a swimming pool to retain warmth in colder climates or in winter months, thereby reducing the cost of heating water in a swimming pool. Regardless, it is to be understood that the thermal insulation properties of the primer 100 are beneficial in any structural applications in which energy savings are desirable, such as for example in schools, churches, homes, and any other buildings for which savings from utility usage and costs may be realized.

As noted above, the primer 100 itself may also suffice as a paint, and therefore a top coating of paint is not needed to thermal insulation and fire protection properties for the surface or substrate 160. It is therefore to be understood that the present invention may be styled as either or both a primer 100 or a paint.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. It is therefore intended that the scope of the invention is not to be limited by any one aspect of this detailed description, or to any one field, profession, or situation.

Additionally, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A primer for both interior and exterior usage in painting applications, comprising:
in a water-based coating applied to a substrate, a plurality of microspheres in an amount that forms a tightly-packed layer during a drying process of the coating, the plurality of microspheres each having a shape allowing them to roll upon each other to enable the water-based coating to spread evenly during an application of the water-based coating and produce a resultant primer that reflects, refracts and dissipates heat by reducing a path for heat transfer throughout the water-based coating;
a flame-retardant additive in an amount that insulates the substrate from fire, by forming a burn-resistant barrier within the water-based coating; and
one or more components that include water, pigments, adhesives, sealants, polymers, and other chemical compounds that promote thermal insulation and flame retardation in a cohesive combination with the plurality of hollow microspheres and the flame-retardant additive.

2. The primer of claim 1, wherein the plurality of microspheres are hollow.

3. The primer of claim 1, wherein the plurality of microspheres are ceramic beads.

4. The primer of claim 3, wherein the ceramic beads are organic.

5. The primer of claim 1, wherein the amount of the plurality of microspheres is approximately 12 ounces per gallon of primer.

6. The primer of claim 1, wherein the amount of the plurality of microspheres is between 8% and 20% percentage weight of the primer.

7. The primer of claim 1, wherein the amount of the plurality of microspheres is approximately 32 ounces per gallon of primer.

8. The primer of claim 1, wherein the amount of the plurality of microspheres is approximately 25% percentage weight of the primer.

9. The primer of claim 1, wherein the flame-retardant additive is present in an amount comprising approximately 6 ounces per gallon of primer.

10. The primer of claim 1, wherein the flame-retardant additive comprises between 3% and 10% percentage weight of the primer.

11. The primer of claim 1, further comprising water in an amount of approximately between 10% to 15% percentage weight of the primer.

12. A coating applied to a substrate in painting applications, comprising:
water, in an amount between approximately between 10%-15% percentage weight of the coating;
a plurality of hollow microspheres in an amount comprising between 20%-30% percentage of the coating that forms a tightly-packed layer during a drying process of the coating, the plurality of hollow microspheres each having a shape allowing them to roll upon each other to enable the coating to spread evenly during an application of the coating and produce a resultant primer that reflects, refracts and dissipates heat by reducing a path for heat transfer throughout the coating; and
a flame-retardant additive in an amount comprising approximately 3%-10% percentage weight of the coating, the flame-retardant additive insulating the substrate from fire, by forming a burn-resistant barrier within the coating.

13. The coating of claim 12, further comprising one or more components that include pigments, adhesives, sealants, polymers, and other chemical compounds that promote the thermal insulation and flame retardation properties of the plurality of hollow microspheres and the flame-retardant additive.

14. The coating of claim 12, wherein the plurality of microspheres are ceramic beads.

15. The coating of claim 14, wherein the ceramic beads are organic.

16. The coating of claim 12, wherein the amount of the plurality of microspheres is approximately 32 ounces per gallon of primer.

17. The coating of claim 12, wherein the amount of the plurality of microspheres is approximately 25% percentage weight of the primer.

18. The coating of claim 12, wherein the flame-retardant additive is present in an amount comprising approximately 6 ounces per gallon of primer.

19. The coating of claim 12, wherein the flame-retardant additive comprises approximately 5% percentage weight of the primer.
